(19) United States
(12) Patent Application Publication
(10) Pub. No.: US 2017/0032280 A1
(43) Pub. Date: Feb. 2, 2017

(54) ENGAGEMENT ESTIMATOR

(71) Applicant: salesforce.com, inc., San Francisco, CA (US)

(72) Inventor: Richard SOCHER, Menlo Park, CA (US)

(73) Assignee: salesforce.com, inc., San Francisco, CA (US)

(21) Appl. No.: 15/221,541

(22) Filed: Jul. 27, 2016

Related U.S. Application Data
(60) Provisional application No. 62/236,119, filed on Oct. 1, 2015.
(60) Provisional application No. 62/197,428, filed on Jul. 27, 2015.

(51) Int. Cl. G06N 99/00; G06N 7/00

(52) U.S. Cl. CPC G06N 99/005; G06N 7/005

(57) ABSTRACT

A machine learning system may be implemented as a set of trained models. A set of trained models, for example, a deep learning system, is disclosed wherein one or more types of media input may be analyzed to determine an associated engagement of the one or more types of media input.

### RELATED APPLICATION

This application claims priority under 35 U.S.C. §119(e) to U.S. Provisional Application No. 62/236,119, entitled “Engagement Estimator”, filed on Oct. 1, 2015 (Attorney Docket No.: SALE 1166-1/2022PROV) and U.S. Provisional Application No. 62/197,428, entitled “Recursive Deep Learning”, filed on Jul. 27, 2015 (Attorney Docket No.: SALE 1167-1/2023PROV), the entire contents of which are hereby incorporated by reference herein.

### INCORPORATIONS

Materials incorporated by reference in this filing include the following:

“Dynamic Memory Network”, U.S. patent application Ser. No. 15/170,884, filed 1 Jun. 2016 (Attorney Docket No. SALE 1164-2/2020US).

### FIELD

The present invention relates to networks, and more particularly to neural networks.

### BACKGROUND

Machine learning is a field of study that gives computers the ability to learn without being explicitly programmed, as defined by Arthur Samuel. As opposed to static programming, trained machine learning algorithms use data to make predictions. Deep learning algorithms are a subset of trained machine learning algorithms that usually operate on raw inputs such as only words, pixels or speech signals.

A machine learning system may be implemented as a set of trained models. Trained models may perform a variety of different tasks on input data. For example, for a text-based input, a trained model may review the input text and identify named entities, such as city names. Another trained model may perform sentiment analysis to determine whether the sentiment of the input text is negative or positive or a gradient in-between.

These tasks train the model machine learning system to understand low level organizational information about words, e.g., how the word is used (identification of a proper name, the sentiment of a collection of words given the sentiment of each). What is needed is teaching and utilizing one or more trained models in higher level analysis, such as predictive activity.

### BRIEF DESCRIPTION OF THE FIGURES

The present invention is illustrated by way of example, and not by way of limitation, in the figures of the accompanying drawings and in which like reference numerals refer to similar elements and in which:

FIG. 1 is a block diagram of an engagement estimator learning system in accordance with one embodiment of the present invention.

FIG. 2 is a flow diagram of an engagement estimator learning system in accordance with one embodiment of the present invention.

FIGS. 3A and 3B are example outputs of an engagement estimator learning system in accordance with one embodiment of the present invention.

FIGS. 4A and 4B are example outputs of an engagement estimator learning system in accordance with one embodiment of the present invention.

FIGS. 5A and 5B are example outputs of an engagement estimator learning system in accordance with one embodiment of the present invention.

FIG. 6 is a block diagram of a computer system that may be used with the present invention.

### DETAILED DESCRIPTION

A system incorporating trained machine learning algorithms may be implemented as a set of one or more trained models. These trained models may perform a variety of different tasks on input data. For example, for a text-based input, a trained model may perform the task of identification and tagging of the parts of speech of sentences within an input data set, and then use the information learned in the performance of that task to identify the places referenced in the input data set by collecting the proper nouns and noun phrases. Another trained model may use the task of identification and tagging of the input data set to perform sentiment analysis to determine whether the input is negative or positive or a gradient in-between.

Machine learning algorithms may be trained by a variety of techniques, such as supervised learning, unsupervised learning, and reinforcement learning. Supervised learning trains a machine with multiple labeled examples. After training, the trained model can receive an unlabeled input and attach one or more labels to it. Each such label has a confidence rating, in one embodiment. The confidence rating reflects how certain the learning system is in the correctness of that label. Machine learning algorithms trained by unsupervised learning receive a set of data and then analyze that data for patterns, clusters, or groupings.

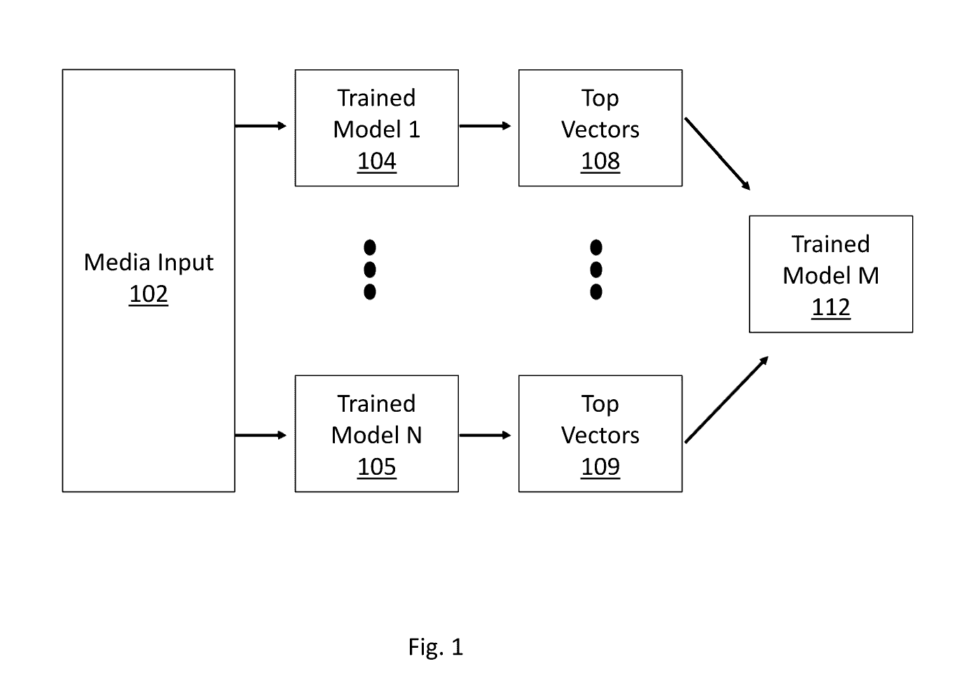

FIG. 1 is a block diagram of an engagement estimator learning system in accordance with one embodiment of the present invention. Input media 102 is applied to one or more trained models 104 and 105. Models are trained on one or more types of media to analyze that data to ascertain engagement of the media. For example, input media 102 may be text input that is applied to trained model 104 that has been trained to determine engagement in text. In another example, input media 102 may be image input that is applied to a trained model 105 that has been trained to determine engagement in images. Input media 102 may include other types of media input, such as video and audio. Input media 102 may also include more than one type of media, such as text and images together, or audio, video and text together.

Trained model 104 is a trained machine learning algorithm that determines vectors of possible outputs from the appropriate media input, along with metadata. In one embodiment, the possible outputs of trained model 104 are a set of engagement vectors and the metadata is an associated confidence. Similarly, trained model 105 is a trained machine learning algorithm that determines vectors of possible outputs from the appropriate media input, along with metadata. In one embodiment, trained models 104 and 105 are convolutional neural networks. In one embodiment, trained models 104 and 105 are recursive neural networks. In one embodiment, the possible outputs are a set of engagement vectors and the metadata is a set of confidences, one for each associated engagement vector. The top vectors 108, 109 of the possible outputs from trained models 104 and 105 are applied to trained model 112. In one embodiment, trained model 112 is a recursive neural network. In one embodiment, trained model 112 is a convolutional neural network. Trained model 112 processes the top vectors 108, 109 to determine an engagement for the set of media input 102. In one embodiment, trained model 112 is not needed.

Engagement is a measurement of social response to media content. When the media content is relevant to social media, such as a tweet including a twitpic posted to Twitter™, engagement may be defined or approximated by one or more factors such as:
1. a number of likes, thumbs up, favorites, hearts, or other indicator of enthusiasm towards the content
2. a number of forwards, reshares, re-links, or other indicator of desire to “share” the content with others.
   Some combination of likes and forwards above a threshold may indicate engagement with the content, while a combination below another threshold may indicate a lack of engagement (or disengagement or disinterest) with the content. While these are two factors indicating engagement with a content, of course other indicators in other combinations are also useful. For example, a number of followers, fans, subscribers or other indicators of the reach or impact of an account distributing the content is relevant to the first level audience for that content and the speed with which it may be disseminated.

A model may be trained in accordance with the present invention to use these and/or other indicia of engagement along with the content to create an internal representation of engagement. This training may be the application of a set of tweets plus factors such as the number of likes of each tweet and the number of shares of each tweet. A model trained this way would be able to receive a prospective tweet and use the information from the learning process to predict the engagement of that tweet after it is posted to Twitter™. When the training set is a combination of an image and some text, the engagement predicted by the trained model may be the engagement of each of that image and that text, and/or the engagement of the combination of the two.

In another example, for the content of a song, perhaps the number of downloads of the song, the number of favorites of the song, the number of tweets about the song, and the number of fan pages created for the artist of the song after the song is released may combine into an indication of engagement for the song. Similarly, for the content of online newspaper headlines and the underlying article, the indicia may be some combination of clicks on or click-throughs from the headline, time on page for the article itself, and shares of the article. The same can apply to classified ads, both online and offline. The calculation of engagement is done through identifying one or more items of metadata that is relevant to the content, and training the trained model on the content plus that metadata.

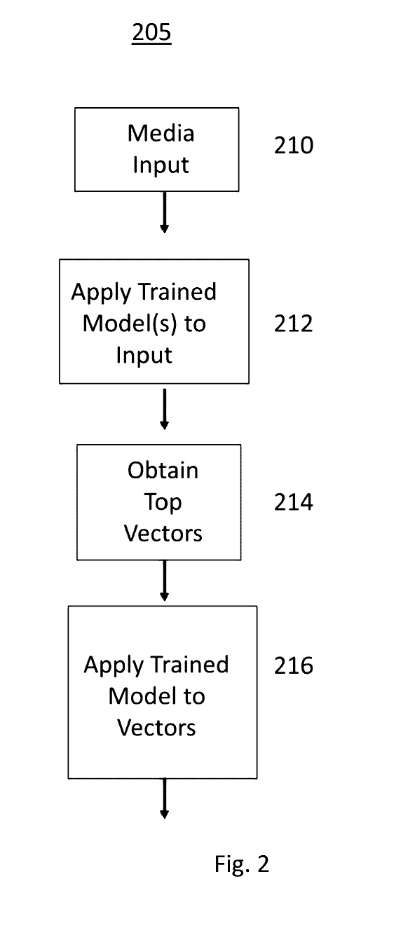

FIG. 2 is a flow diagram of an engagement estimator learning system in accordance with one embodiment of the present invention. Media input 210 is applied to one or more trained model(s) 212 to obtain top vectors 214. In one embodiment, top vectors 108, 109 are used to calculate the overall engagement. In one embodiment, top vectors 108, 109 are applied to one or more trained model(s) 216 to determine the overall engagement.

When the engagement estimator learning system of FIG. 2 is used to predict the Twitter™ social media response of a combination of an image and some text into a prospective tweet, the engagement predicted by the trained model allows the author of the prospective tweet to understand whether the desired response is likely. When the words are not engaging but the image is engaging, the words may be re-written. In some embodiments, the engagement estimator provides suggestions of different ways to communicate the same type of information, but in a more engaging manner, for example, by rearranging word choice to put more positive words in the beginning of the tweet. When the image is not engaging, another image may be chosen. In some embodiments, the engagement estimator provides suggestions of other images that will increase the overall engagement of the tweet. In some embodiments, those suggestions may be correlated to the language used in the text.

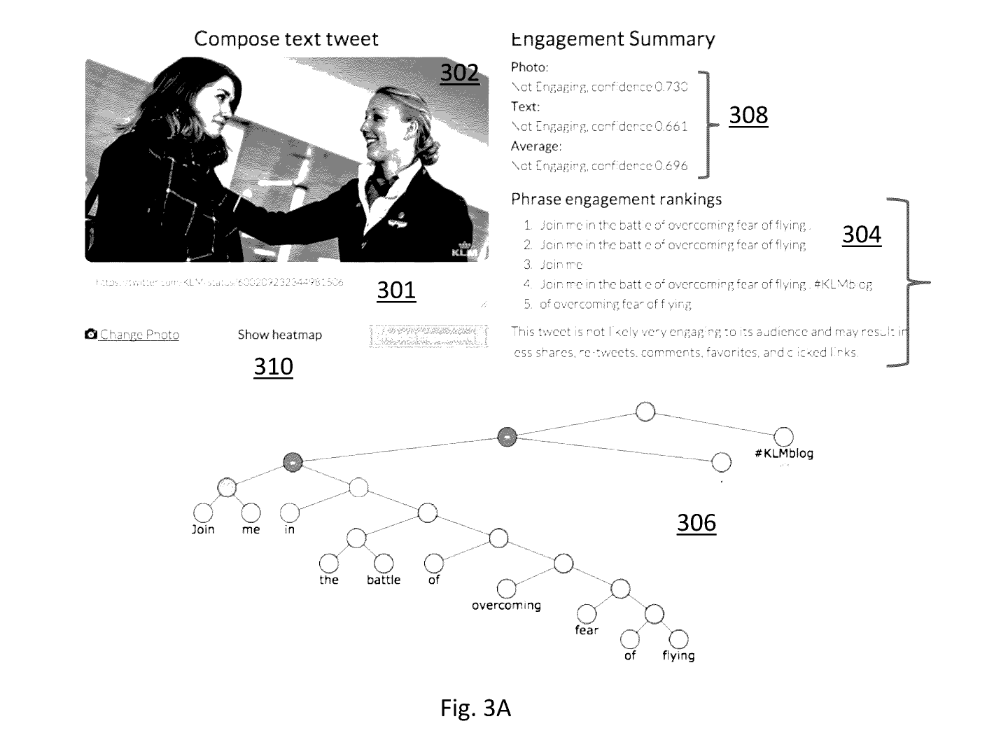

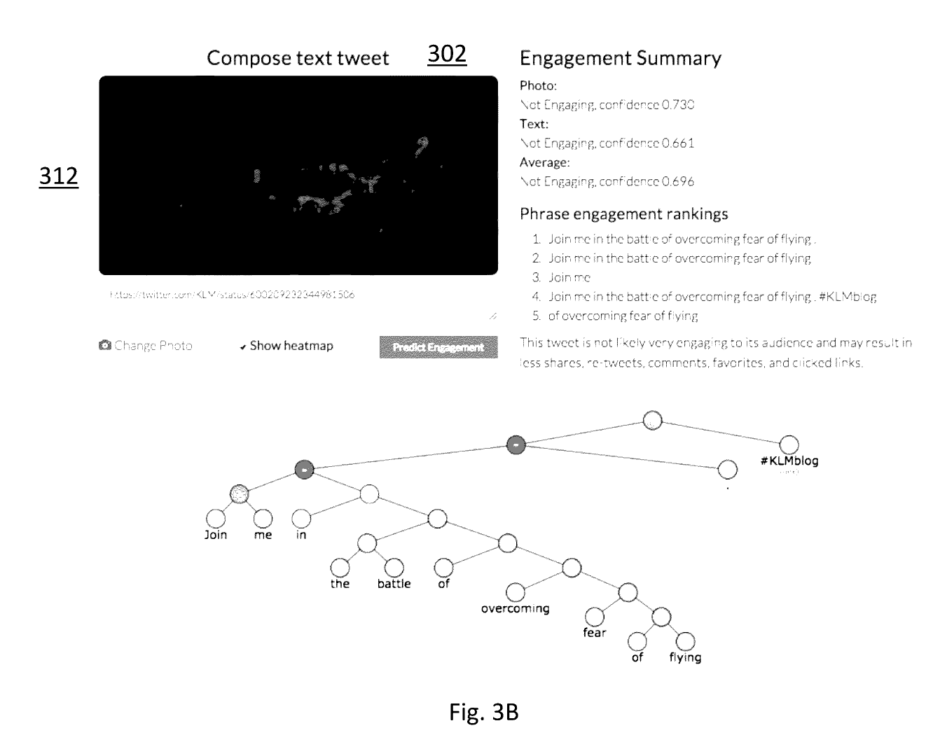

FIGS. 3A and 3B are example outputs of an engagement estimator learning system in accordance with one embodiment of the present invention. In one embodiment, the engagement estimator receives input relevant to a prospective tweet. In one embodiment, media input to the trained models consists of a link to a prospective tweet 301. Text entered in a text box of may also be used, an upload of a prospective tweet, or other manner of applying the media input to the estimated engagement learning system. Tweet 301 consists of an image 302 and a statement 304. The engagement estimator applies image 302 and statement 304 to one or more trained models to obtain an engagement and an associated confidence 308, including a separate engagement score and confidence for the photo, for the text, and for the photo and text together. In one embodiment, the engagement vector for the photo and the engagement for the text from the trained models are applied to another trained model to determine the engagement score for the photo and text together. In one embodiment, this trained model is a recursive neural network. In the present example, there is a high degree of probability that neither the image nor the statement are very engaging. In one embodiment, at least two types of media must be input into the system.

Note the predictive nature of the engagement estimator system. In the past, publishing one or more pieces of media, for example, in social media, had an unknown response. The engagement estimator allows predictive analysis of input media to determine the engagement. This engagement may be applied to improving the media, for example, changing the wording of a text or choosing another picture. It may be checking the other advertisements on a web page to ensure that the brand an advertisement is promoting isn't devalued by being placed next to something inappropriate. Engagement may be used for a variety of purposes, for example, it may be correlated to Twitter™ responses—estimating the number of favorites and retweets the input media will receive. A brand may craft a tweet with feedback on engagement of each iteration.

Text engagement map 306 shows which portions of statement 304 contribute to overall engagement. Show heatmap command 310 shows heatmap image 312, to better understand which parts of the photo are more engaging than other parts. In one embodiment, heatmap image 312 shows the amount of contribution each pixel gave to the overall engagement of the photo. In one embodiment, options for changing the statement to a different statement that may be more engaging may be displayed. In one embodiment, suggestions for a more engaging photo may be displayed.

While FIGS. 3A and 3B have been described with respect to a tweet, note that any social media posting may be analyzed this way. For example, a post on a social media site such asFacebook™, an article on a news site, a posting on a blog site, a song or audiobook uploaded to iTunes™ or other music distribution site, a post on a user moderated site such as reddit™, or even a magazine or newspaper article on an online or offline magazine or newspaper. In some embodiments, trained models may predict responses across social media sites. For example, the engagement of a photo and associated text trained on Twitter™ may be used to approximate the engagement of the same photo and associated text on in a newspaper, online or offline. In some embodiments, models are trained on one type of social media and predict only on that type of social media. In some embodiments, models are trained on more than one type of social media.

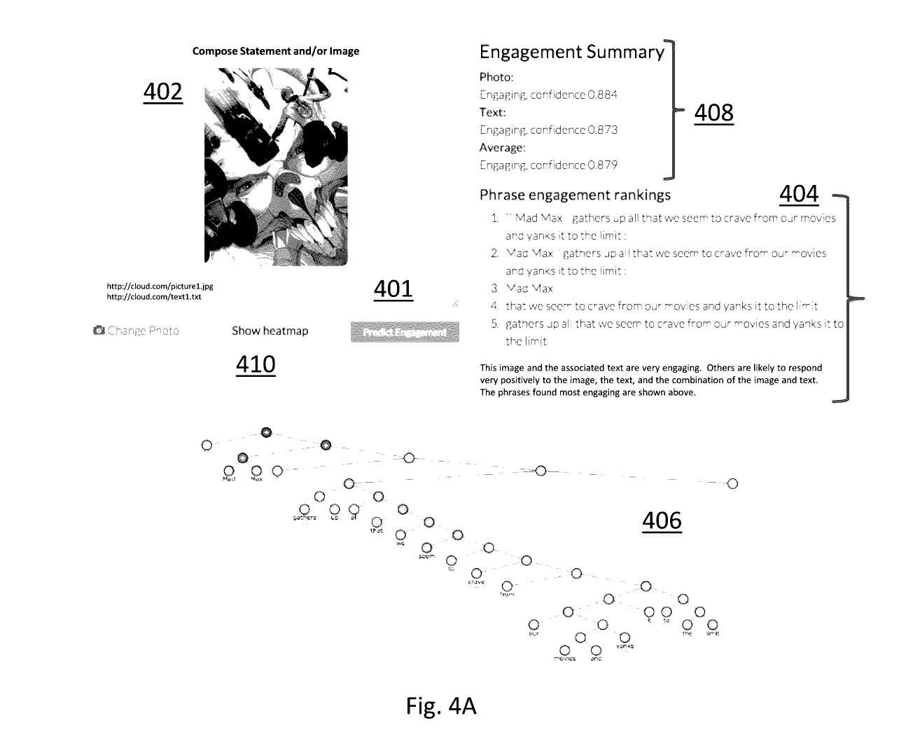

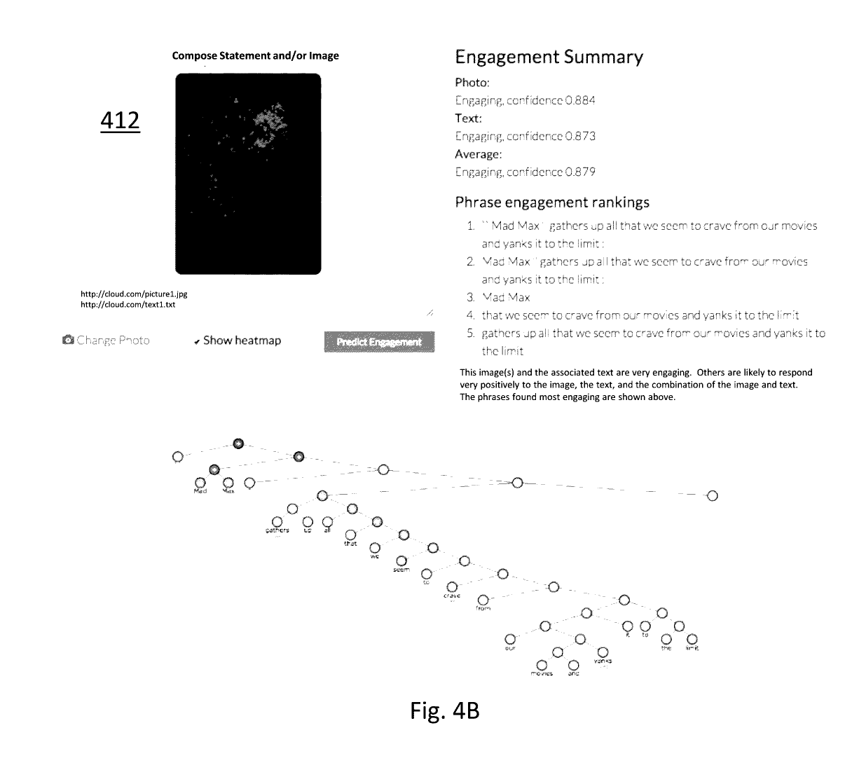

FIGS. 4A and 4B are example outputs of an engagement estimator learning system in accordance with one embodiment of the present invention. In one embodiment, media input to the trained models consists of a link 401 to an image 402 coupled with an audio recording that has been transcribed into a statement 404. Media input may be applied in varying ways, for example, choosing text or an image from a local hard disk drive, via a URL, or dragged and dropped from one location to the engagement estimator system. Other types of input methods may be made, for example, applying a picture and a statement directly, or linking to a web page having the image and audio files. The engagement estimator applies image 402 and statement 404 to one or more trained models to obtain an engagement and a confidence 408, including a separate engagement score and confidence for the photo, for the text, and for the photo and text together. In one embodiment, the engagement score for the photo and text together is calculated by combining the probabilities of engagement given the image and the text. In this example, both the image and the statement are very engaging with a high degree of probability.

Text engagement map 406 shows which portions of statement 304 contribute to overall engagement. Show heatmap command 410 shows heatmap image 412, to better understand which parts of the photo are more engaging than others. In one embodiment, options for changing the statement to a different statement that may be more engaging may be displayed. In one embodiment, suggestions for a more engaging photo may be displayed. This information may be used to post the photo and associated text to a social media site such as Pinterest™, LinkedIn™, or other social media site.

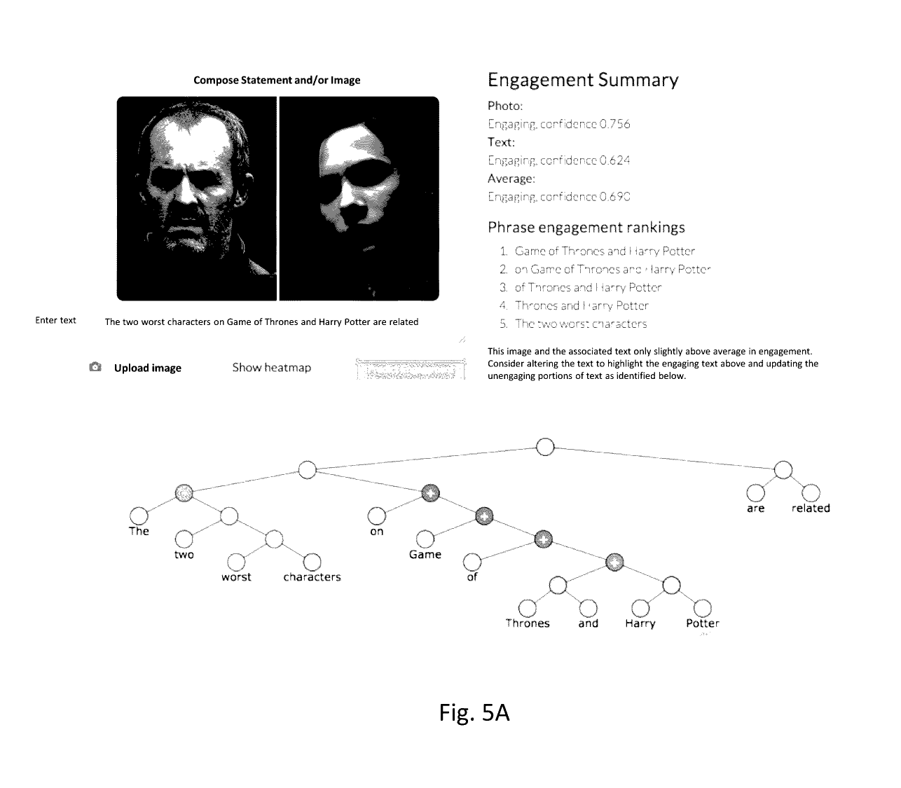

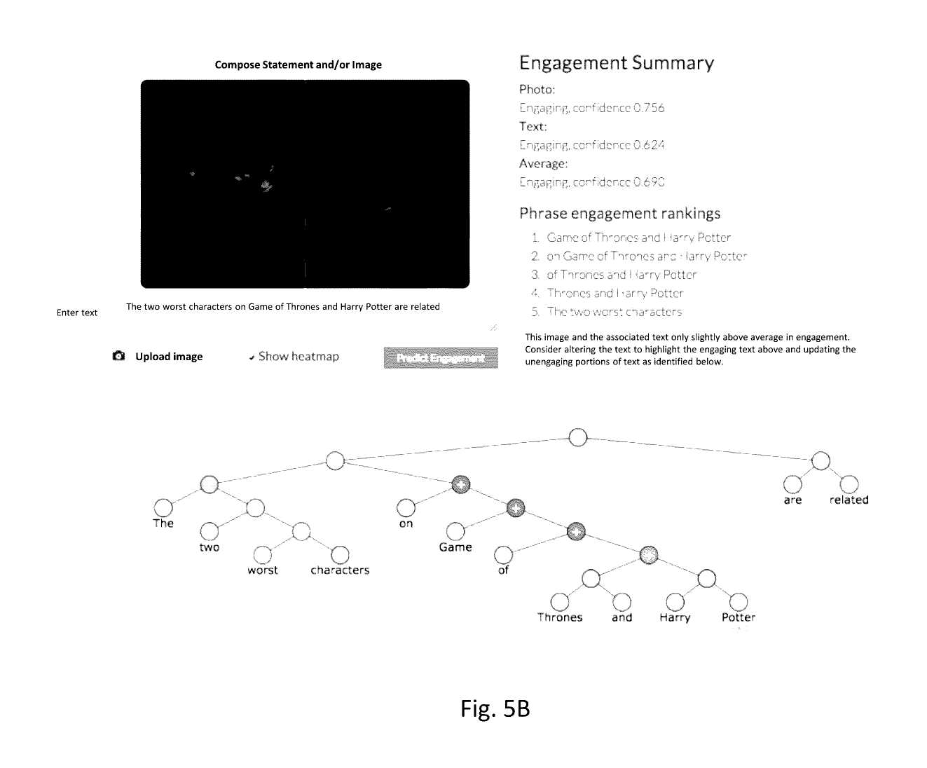

FIGS. 5A and 5B are example outputs of an engagement estimator learning system in accordance with one embodiment of the present invention. Similar to FIGS. 4A and B and FIGS. 3A and B, one or more images and text are applied to trained models to obtain an engagement estimate for two images and associated text.

Other embodiments may have other combinations of media. For example, a song may be input to the engagement estimator. In some embodiments, the image or images may be uploaded by interaction with an upload button and the text may be entered directly into a text box.

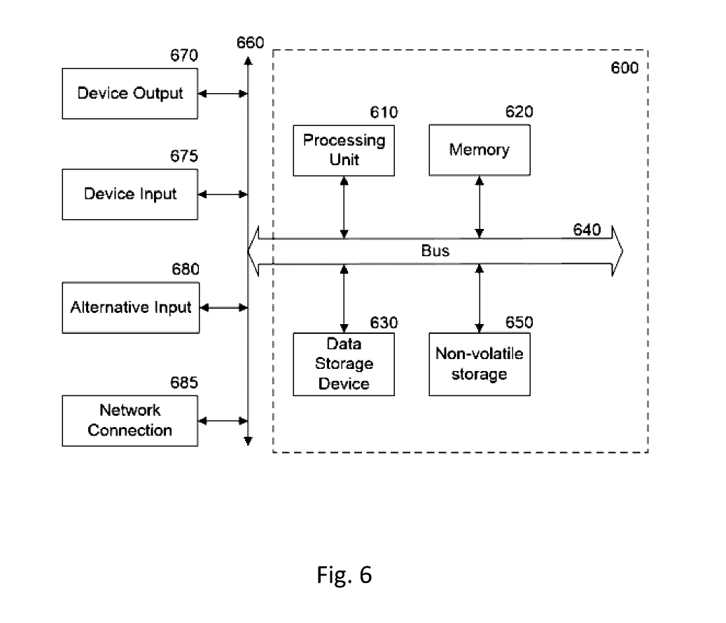

FIG. 6 is a block diagram of a computer system that may be used with the present invention. It will be appreciated by those of ordinary skill in the art that any configuration of the particular machine implemented as the computer system may be used according to the particular implementation. The control logic or software implementing the present invention can be stored on any machine-readable medium locally or remotely accessible to a processor. A machine-readable medium includes any mechanism for storing information in a form readable by a machine (e.g. a computer). For example, a machine readable medium includes read-only memory (ROM), random access memory (RAM), magnetic disk storage media, optical storage media, flash memory devices, or other storage media which may be used for temporary or permanent data storage. In one embodiment, the control logic may be implemented as transmittable data, such as electrical, optical, acoustical or other forms of propagated signals (e.g. carrier waves, infrared signals, digital signals, etc.).

In the foregoing specification, the disclosed embodiments have been described with reference to specific exemplary embodiments thereof. It will, however, be evident that various modifications and changes may be made thereto without departing from the broader spirit and scope of the invention as set forth in the appended claims. Similarly, what process steps are listed, steps may not be limited to the order shown or discussed. The specification and drawings are, accordingly, to be regarded in an illustrative rather than a restrictive sense.

1.-3. (canceled)

4. An engagement estimator system to estimate an engagement level for media input, the system including:
a first level comprising a plurality of trained model recursive neural networks including at least:
a first trained model recursive neural network trained to determine a first engagement, including a social response to media content in text portions of the media input; and
a second trained model recursive neural network trained to determine a second engagement, including a social response to media content in image portions of the media input;
wherein each of the trained model recursive neural networks provides as output a set of possible engagement vectors appropriate to the media input portion applied to each respective trained model recursive neural network and a metadata set of confidence levels corresponding to the possible engagement vectors; and
a second level comprising at least:
a single trained model recursive neural network trained to process an input including select ones of the set of possible engagement vectors appropriate to each media portion applied to the plurality of trained model recursive neural networks of the first level, the selection in accordance with the metadata set of confidence levels corresponding to the possible engagement vectors;
wherein the single trained model recursive neural network provides as output an engagement output for the set of media input; and
wherein the trained model recursive neural networks of the first level and the trained model recursive neural network of the second level are trained by receiving repeated application of a training set including a set of media inputs and a set of engagement indicia and storing the set of media inputs and a set of engagement indicia in a tangible machine readable memory for use in estimating engagement of new media inputs; and
wherein once trained, the trained model recursive neural networks of the first level and the trained model recursive neural network of the second level receive a prospective media input and use information from learning repeated application of a set of media inputs and a set of engagement indicia to predict an engagement for the prospective media input prior to the prospective media input being posted to a network server.

5. The system of claim 4, wherein the indicia includes at least one selected from:
i. a number of likes, thumbs up, favorites, hearts, or other indicator of enthusiasm towards the content;
ii. a number of forwards, reshares, re-links, or other indicator of desire to “share” the content with others; and
iii. a number of followers, fans, or subscribers.

6. The system of claim 4, wherein the training set includes one or a combination of indicia subjected to a threshold to determine whether the indicia is engaging (“of interest”) or not engaging (“not interesting”).

7. The system of claim 4, wherein the second level determines that the text portion is not engaging but the image portion is engaging, the system providing indication that the text may be re-written.

8. The system of claim 4, wherein the second level determines that the image portion is not engaging but the text portion is engaging, the system providing indication that the image may be replaced.

9. The system of claim 4, the first level further including a third trained model recursive neural network trained to determine a third engagement, including a social response to media content in audio portions of the media input.

10. The system of claim 4, the first level further including a fourth trained model recursive neural network trained to determine a fourth engagement, including a social response to media content in video portions of the media input.

11. The system of claim 4, wherein the prospective media input includes a 140 character message.

12. The system of claim 4, wherein the prospective media input includes a status update in “tweet” form.

13. An engagement estimation method to estimate an engagement level for media input, the method including:
storing for a first level a plurality of trained model recursive neural networks, the neural networks including at least:
a first trained model recursive neural network trained to determine a first engagement, including a social response to media content in text portions of the media input; and
a second trained model recursive neural network trained to determine a second engagement, including a social response to media content in image portions of the media input;
wherein each of the trained model recursive neural networks provides as output a set of possible engagement vectors appropriate to the media input portion applied to each respective trained model and a metadata set of confidence levels corresponding to the possible engagement vectors; and
storing for a second level at least a single trained model recursive neural network trained to process an input including select ones of the set of possible engagement vectors appropriate to each media portion applied to the plurality of trained model recursive neural networks of the first level, the selection in accordance with the metadata set of confidence levels corresponding to the possible engagement vectors;
wherein the single trained model provides as output an engagement output for the set of media input; and
wherein the trained model recursive neural networks of the first level and the trained model recursive neural network of the second level are trained by receiving repeated application of a training set including a set of media inputs and a set of engagement indicia and storing the set of media inputs and a set of engagement indicia in a tangible machine readable memory for use in estimating engagement of new media inputs; and
wherein once trained, the trained model recursive neural networks of the first level and the trained model recursive neural network of the second level receive a prospective media input and use information from learning repeated application of a set of media inputs and a set of engagement indicia to predict an engagement for the prospective media input prior to the prospective media input being posted to a network server.

14. The method of claim 13, wherein the indicia includes at least one selected from:
i. a number of likes, thumbs up, favorites, hearts, or other indicator of enthusiasm towards the content;
ii. a number of forwards, reshares, re-links, or other indicator of desire to “share” the content with others; and
iii. a number of followers, fans, or subscribers.

15. The method of claim 13, wherein the training set includes one or a combination of indicia subjected to a threshold to determine whether the indicia is engaging (“of interest”) or not engaging (“not interesting”).

16. The method of claim 13, wherein when the second level determines that the text portion is not engaging but the image portion is engaging, further including providing indication that the text may be re-written.

17. The method of claim 13, wherein the second level determines that the image portion is not engaging but the text portion is engaging, further including providing indication that the image may be replaced.

18. The method of claim 13, the storing for the first level further including storing a third trained model recursive neural network trained to determine a third engagement, including a social response to media content in audio portions of the media input.

19. The method of claim 13, the storing for the first level further including storing a fourth trained model recursive neural network trained to determine a fourth engagement, including a social response to media content in video portions of the media input.

20. The method of claim 13, wherein the prospective media input includes a 140 character message.

21. The method of claim 13, wherein the prospective media input includes a status update in “tweet” form.

22. A non-transitory computer readable storage medium impressed with computer program instructions to estimate an engagement level for media input, the instructions, when executed on a processor, implement a method comprising:
storing for a first level a plurality of trained model recursive neural networks, the neural networks including at least:
a first trained model recursive neural network trained to determine a first engagement, including a social response to media content in text portions of the media input; and
a second trained model recursive neural network trained to determine a second engagement, including a social response to media content in image portions of the media input;
wherein each of the trained model recursive neural networks provides as output a set of possible engagement vectors appropriate to the media input portion applied to each respective trained model and a metadata set of confidence levels corresponding to the possible engagement vectors; and
storing for a second level at least a single trained model recursive neural network trained to process an input including select ones of the set of possible engagement vectors appropriate to each media portion applied to the plurality of trained model recursive neural networks of the first level, the selection in accordance with the metadata set of confidence levels corresponding to the possible engagement vectors;
wherein the single trained model provides as output an engagement output for the set of media input; and
wherein the trained model recursive neural networks of the first level and the trained model recursive neural network of the second level are trained by receiving repeated application of a training set including a set of media inputs and a set of engagement indicia and storing the set of media inputs and a set of engagement indicia in a tangible machine readable memory for use in estimating engagement of new media inputs; and
wherein once trained, the trained model recursive neural networks of the first level and the trained model recursive neural network of the second level receive a prospective tweet and use information from learning repeated application of a set of media inputs and a set of engagement indicia to predict an engagement for the tweet prior to the tweet being posted to twitter.
